(19) United States
(12) Patent Application Publication
(10) Pub. No.: US 2005/0285581 A1
(43) Pub. Date: Dec. 29, 2005

(54) Interface circuit of a Hall IC and system for using them

(76) Inventor: Hirohiko Hayakawa, Yoshii (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/111,763

(22) Filed: Apr. 22, 2005

(30) Foreign Application Priority Data
Jun. 23, 2004 (JP) 2004-184572

(51) Int. Cl. G05F 1/40

(52) U.S. Cl. 323/282

(57) ABSTRACT

To provide a Hall element interface circuit that, regardless of the specifications of Hall elements used, contributes to correct detection of magnetism, reduction in heating in the Hall elements, and an increase in reliability, and a system using the Hall element interface circuit. A power supply circuit such as a series regulator that generates drive voltage applied to a Hall element, and a comparator or operational amplifier as a current detecting unit that detects changes in a current flowing through the Hall element and outputs detection results are provided, and a Hall element interface circuit is provided to construct an interface circuit that intervenes between the Hall element and a controller or a bus capable of coupling to the controller.

### CROSS-REFERENCE TO RELATED APPLICATION

The present application claims priority from Japanese patent application No. 2004-184572 filed on Jun. 23, 2004, the content of which is hereby incorporated by reference into this application.

### BACKGROUND OF THE INVENTION

The present invention relates to an effective technique for use in an interface circuit of a magnetic sensor using a Hall element. It relates to an effective technique for use in, for example, an interface-use semiconductor integrated circuit in which a power supply circuit for generating a drive voltage applied to a Hall element and a current detecting circuit for detecting a current flowing through the Hall element are constructed on one semiconductor chip to output detection results.

Conventionally, Hall elements having magnetism-electricity conversion properties are used as various measuring devices and sensors in a control system. Since the Hall elements are contactless switches and have excellent durability, they are used as sensors in various fields, taking advantage of their properties. As an example of a control system that uses the Hall elements as sensors, a car engine control system is known which detects an angle of a crankshaft and a transmission rotating speed to control the engine.

By the way, there are two types of conventional Hall elements: three-terminal Hall elements that detect a change in magnetism and outputs a detection signal by a transistor of an open collector system, and two-terminal Hall elements that have only a power terminal and detect a change in magnetism as a change in current. A three-terminal Hall element is described in patent document 1, and a two-terminal Hall element is described in patent document 2.
[Patent document 1] Japanese Unexamined Patent Publication No. Hei 10(1998)-071927
[Patent document 2] Japanese Unexamined Patent Publication No. Hei 10(1998)-253728

### SUMMARY OF THE INVENTION

FIG. 8 shows a detection system that uses a three-terminal Hall IC, and FIG. 9 shows a detection system that uses a two-terminal Hall IC. In the detection system of FIG. 8 that uses a three-terminal Hall IC, a collector of an output transistor 12 within a Hall IC 10 is coupled to an output terminal 13 of the output transistor 12, and the output terminal 13 of the Hall IC 10 and a detection signal input terminal 21 of the control unit 20 are coupled by a signal line L3. A load resistor 40 is coupled between a power line L1 of the control unit 20 and the signal line L3, and according to changes in magnetism, the output transistor 12 is turned on or off, a current flowing through the load resistor 40 changes, and the amount of voltage drop changes. Therefore, the detection system is constructed to detect the amount of voltage drop in the load resistor 40 by the control unit 20.

On the other hand, in the detection system of FIG. 9 that uses the two-terminal Hall IC, the collector of the output transistor 12 within the Hall IC 10 is coupled to a power supply voltage terminal, the load resistor 40 is provided on the power line L1, and according to changes in magnetism, the output transistor 12 is turned on or off, and a current flowing through the load resistor 40 is changed. A comparator 60, which is provided on the part of the control unit 20, compares the voltage of one terminal of the load resistor 40 with the reference voltage Vref, detects changes in voltages between the terminals of the resistor, and inputs the result to the control unit 20.

As is apparent from comparisons between FIGS. 8 and 9, the detection system that uses the three-terminal Hall IC requires a signal line L3 for transmitting a detection signal in addition to the two power lines L1 and L2, while the detection system that uses the two-terminal Hall IC requires only the two power lines L1 and L2. Particularly, as in a car control system, if Hall elements are provided in positions distant from a control unit and a three-terminal Hall IC is used in a system that tends to use a large number of them, wiring harnesses for coupling the control unit with the Hall ICs increase, causing undesirable situations such as an increase in costs and difficulty in maintenance operations and detection in failed portions.

On the other hand, the system that uses the two-terminal Hall IC has the advantage that wiring harnesses can be decreased, but has difficulty insetting the reference voltage Vref of the comparator 50 according to an insertion position of the load resistor 40 and the resistance value of the load resistor 40 to be inserted. Furthermore, if the specifications of the Hall IC to be used and system configuration are different, settings would become more complicated because an optimum setting value of the reference voltage Vref is different. Since the setting values of the reference voltage Vref of the comparator 50 are thus different, an interface IC responsible for input and output between plural Hall ICs and the control unit has not been conventionally provided.

Furthermore, in the system that uses the two-terminal Hall IC, the Hall IC produces higher heating than the three-terminal Hall IC, resulting in reduced reliability. Hereinafter, reasons for it will be described in detail.

The three-terminal Hall IC generally has current consumption of about 5 mA, and there is little difference between the off-time and on-time currents of an output transistor. The reason for it is that, by setting the load resistor 40 at a high resistance value, a current can be easily detected by making a voltage drop amount large even if the on-time current is small. Accordingly, if the power supply voltage Vcc of a battery is assumed to be 12 V, off-time and on-time heating amounts of the Hall IC each are about 60 mW. In other words, in the system that uses the three-terminal Hall IC, heating by output current occurs primarily in the load resistor 40, and little in the Hall IC. Specifically, since thermal resistance of a Hall IC is generally about 200° C./W to 300° C./W, temperature rise due to heating of a three-terminal Hall IC is 12° C. to 18° C., assuming that a heating amount is 60 mW.

On the other hand, off-time current consumption of the two-terminal Hall IC is about 5 mA, which is almost the same as that of the three-terminal Hall IC, while on-time current consumption is about 15 mA. The reason for it is that a power line must have low resistance as measures against noises and a large current must be supplied using the load resistor 40 having a resistance value of about 100 Ω, in which case an on-time current must be about 10 mA greater than an off-time current to obtain about 1 V as a voltage change amount when the resistor of 100 Ω is used.

Accordingly, when power supply voltage Vcc of the battery is 12 V, since a voltage lower by voltage drop in the load resistor is applied to the Hall IC, a heating amount in the Hall IC at the off time is about 57.5 mW from the following expression:
(12 (V)−100(Ω)×5(mA))×5(mA)=(12−100×0.005)×0.005=0.0575 W
Temperature rise due to heating of the Hall IC at this time is 11° C. to 17° C. because the thermal resistance of the Hall IC is about 200° C./W to 300° C./W.

A heating amount in the Hall IC at the on time is about 158 mW from the following expression:
(12(V)−100(Ω)×15(mA))×5(mA)=(12−100×0.015)×0.015=0.158 W
Temperature rise due to heating of the Hall IC at this time is 25° C. to 47° C. In other words, in the system that uses the two-terminal Hall IC, heating by output current occurs primarily in the Hall IC, and relatively little in the load resistor.

In a car engine control system, since Hall ICs may be disposed in relatively hot portions such as an engine and transmissions, the temperature of the Hall IC disposed in such portions reaches about 200° C. in the case of power supply voltage of 12 V when temperature rise due to self-heating is added, and a higher temperature in the case of higher power supply voltages such as 24V and 48V.

Although an invention on an interface circuit of Hall elements is disclosed in the above-mentioned patent document 2, the interface circuit of the prior application and the interface circuit of the present application have entirely different objects though they are the same in the name of interface.

An object of the present invention is to provide a Hall element interface circuit that contributes to reduction in the number of wirings, reduction in heating in Hall elements, and an increase in reliability in a system using the Hall elements as sensors, and the system using the Hall element interface circuit.

Another object of this present invention is to provide a Hall element interface circuit that, regardless of the specifications of Hall elements used, contributes to correct detection of magnetism, reduction in heating in the Hall elements, and an increase in reliability, and a system using the Hall element interface circuit.

Another object of the present invention is to provide a highly versatile Hall element interface circuit that can output detection results to a controller having serial communication functions or an interface capable of coupling to a bus constituting LAN (local area network), and a system using the Hall element interface circuit.

The above-mentioned and other objects and novel characteristics of the present invention will become apparent from the description of this specification and the accompanying drawings.

The typical disclosures of the invention will be summarized in brief as follows.

A power supply circuit such as a series regulator that generates drive voltage applied to a Hall element, and a comparator or operational amplifier as a current detecting unit that detects changes in a current flowing through the Hall element and outputs detection results are provided to construct a Hall element interface circuit that intervenes between the Hall element and a controller or a bus capable of coupling to the controller.

According to the above-mentioned unit, since the power supply circuit is provided to generate drive voltage applied to the Hall element, the drive voltage applied to the Hall element can be reduced to curb heating. Since a resistance element for detecting a current does not need to be coupled to a power line, the impedance of the power line can be reduced, whereby a current supplied to the Hall element can be reduced to curb heating, and noise on the power line can be reduced.

The current detecting unit that detects changes in a current flowing through the Hall element comprises: a transistor controlled by identical control voltage, provided in parallel with a control transistor constituting a series regulator; a resistance element that converts the current of the transistor into voltage; and a comparator that compares the converted voltage with a predetermined level.

By this construction, changes in magnetism can be detected using a two-terminal Hall element, the number of wirings can be reduced, and changes in currents can be detected without fail even if a current supplied to the Hall element is reduced. Furthermore, since the resistance value of the resistance element for current-voltage conversion and the reference voltage of the comparator can be uniquely set regardless of the specifications of the Hall element used, it is easy to put the interface circuit into a semiconductor integrated circuit and possible to provide a compact and inexpensive Hall element interface circuit.

The above-mentioned interface circuit is provided with plural power supply circuits and plural current detecting units which are constructed as semiconductor integrated circuits on one semiconductor chip. By this construction, an interface circuit capable of dealing with plural Hall elements can be put into a monolithic IC, contributing to reduction in the number of parts and miniaturization of the entire system.

Furthermore, the above-mentioned interface circuit is provided with a parallel-serial conversion circuit that outputs detection results of plural current detecting units as serial data, or a bus interface corresponding to general-purpose communication protocols. By this construction, regardless of the specifications of Hall elements used and the specifications of a controller, detection signals corresponding to states of the Hall elements can be inputted to the controller.

Effects obtained by typical disclosures of the invention will be described in brief as follows.

According to the present invention, it is possible to realize a Hall element interface circuit that contributes to reduction in the number of wirings, reduction in heating in Hall elements, and an increase in reliability in a system using the Hall elements as sensors, and the system using the Hall element interface circuit.

### BRIEF DESCRIPTION OF THE DRAWINGS

FIG. 1 is a block diagram showing a first embodiment of an interface circuit of Hall elements according to the present invention, and an example of the configuration of a control system using the interface circuit;

FIG. 2 is a block diagram showing a first embodiment of an interface circuit of Hall elements according to the present invention, and an example of the configuration of a control system using the interface circuit;

FIG. 3 is a block diagram showing a variant of an interface circuit of a second embodiment;

FIG. 4 is a block diagram showing another variant of an interface circuit of a second embodiment;

FIG. 5 is a block diagram showing a third embodiment of an interface circuit of Hall elements according to the present invention;

FIG. 6 is a timing chart showing timings of signals of different parts of a current detecting circuit in an interface circuit of a third embodiment;

FIG. 7 is a block diagram showing a fourth embodiment of an interface circuit of Hall elements according to the present invention;

FIG. 8 is a block diagram showing an example of the configuration of a control system that uses a conventional three-terminal Hall IC; and

FIG. 9 is a block diagram showing an example of the configuration of a control system that uses a conventional two-terminal Hall IC.

### DETAILED DESCRIPTION OF THE PREFERRED EMBODIMENTS

Hereinafter, preferred embodiments of the present invention will be described with reference to the accompanying drawings.

FIG. 1 shows a first embodiment of an interface circuit of Hall elements according to the present invention, and an example of the configuration of a control system using the interface circuit.

In FIG. 1, the reference numeral 10 designates a Hall IC; 20 designates control unit comprising a microcomputer and the like; and 30 designates an interface circuit according to the present invention. The control unit 20, for example, in an engine control system, controls ignition timing of a spark plug on the basis of a detection signal from a Hall IC (sensor) that detects a crank angle provided on a crankshaft. The Hall IC 10 includes a Hall element 11 having magnetism-electricity conversion properties and a transistor 12 that is turned on or off according to states of the Hall element 11.

Though there is no particular limitation, the IC 10 in this embodiment uses a two-terminal element, which has a power terminal to which drive voltage Vbias is applied, and a ground terminal to which ground potential GND is applied. Though not shown, the Hall IC 10 may be provided with a temperature compensating circuit for guaranteeing stable output regardless of temperature fluctuations of the chip. A description of such a temperature compensating circuit is omitted because it is known in the patent document 1 and the like, and has no direct relation with the present invention.

The interface circuit 30 of this embodiment includes a series regulator 31 as a power supply circuit that receives DC power Vcc from the battery 50 and generates drive voltage Vbias applied to the Hall IC 10, and a current detecting circuit 32 that detects current supplied to the Hall IC 10 via a power line L1 for coupling the interface circuit 30 and the Hall IC 10. Though there is no particular limitation, the series regulator 31 and the current detecting circuit 32 that constitute the interface circuit 30 are formed as a semiconductor integrated circuit on one semiconductor chip such as a single-crystal silicon by a known CMOS manufacturing process.

The series regulator 31 includes: a voltage control MOS transistor Q1 provided between a voltage input terminal P1 coupled to a positive terminal of the battery 50, and a voltage output terminal P2 to which the power line L1 for supplying power to the Hall IC 10 is coupled; and an operational amplifier (operational-amplifier circuit) OP1 that is applied with drain voltage of the transistor Q1, that is, output drive voltage Vbias to its inversion input terminal, and with reference voltage Vb to its non-inversion input terminal. An output voltage of the operational amplifier OP1 is applied to the gate terminal of the voltage control MOS transistor Q1.

By this construction, the voltage control MOS transistor Q1 is subjected to feedback control by the operational amplifier OP1 so that the output drive voltage Vbias matches the reference voltage Vb. In this embodiment, by setting the reference voltage Vb to a value such as 2.5V, the series regulator 31 converts 12-V DC power from the battery 50 into 2.5-V drive voltage Vbias and outputs it. By making the reference voltage Vb adjustable or providing an external terminal for externally setting the reference voltage Vb, the output drive voltage Vbias can be set according to the specifications of the Hall IC used.

The current detecting circuit 32 includes: a MOS transistor Q2 that is provided in parallel with the voltage control MOS transistor Q1 and applied with an output voltage of the operational amplifier OP1 to its gate terminal like Q1; a resistor Rs for current-voltage conversion coupled in series with the MOS transistor Q2 between the voltage input terminal P1 and a ground terminal P3 to which ground potential is applied; and a comparator CMP that compares voltage converted by the resistor Rs and predetermined comparison potential Vc. A bipolar transistor may be used in place of the MOS transistors Q1 and Q2.

The voltage control MOS transistor Q1 should preferably be a large-sized element having small on-resistance so as to supply a sufficient amount of current to the Hall IC 10, while the MOS transistor Q2 should preferably be small-sized to minimize current consumption of the interface circuit 30. Specifically, the size ratio (gate width ratio) between the transistors Q1 and Q2 is set to a value such as 100:1 to 1000:1. With such a size ratio, even if the amount of currents flowing through Q2 is reduced, by increasing the resistance value of the resistor Rs, voltage required for detection can be generated.

Furthermore, as the comparator CMP, it is desirable to use the one that has hysteresis properties. By using the comparator CMP having hysteresis properties, even when noise is generated in the power line or a detected current changes due to temperature fluctuations and the like, correct detection output is obtained ignoring them.

Although, in this embodiment, an on-chip element is used as the resistance element Rs, the interface circuit 30 may be provided with an external terminal so that the resistance element Rs can be coupled as an external element. As a resistance value of the resistance element Rs, such a value that causes a voltage of 0.1 to 1V to be generated due to voltage drop is selected. In this embodiment, a comparator is used to output binarized detection results to the control unit 20. However, a linear amplifier may be provided in place of the comparator to output an analog voltage corresponding to a current supplied to the Hall IC 10, that is, a magnetism detection amount of the Hall IC 10.

In the system using the interface circuit 30 of this embodiment, since drive voltage Vbias supplied to the Hall IC 10 is 2.5V, if it is assumed that off-time current consumption of the Hall IC 10 is 5 mA, on-time current consumption is 15 mA, and thermal resistance is 200° C./W to 302° C./W, off-time power consumption of the Hall IC is 12.5 mW and temperature rise due to heating is 2.5° C. to 3.8° C., while on-time power consumption is 37.5 mW and temperature rise due to heating is only 7.5° C. to 11.3° C.

Accordingly, even if ambient temperature is 150° C., the temperature of the Hall IC does not reach 165° C., and it is easy to maintain the temperature of the Hall IC 10 below an operation compensating temperature. In the system that uses the interface circuit 30 of this embodiment, since the power line can be brought into low impedance, advantageously, noises are hardly generated on the power lines.

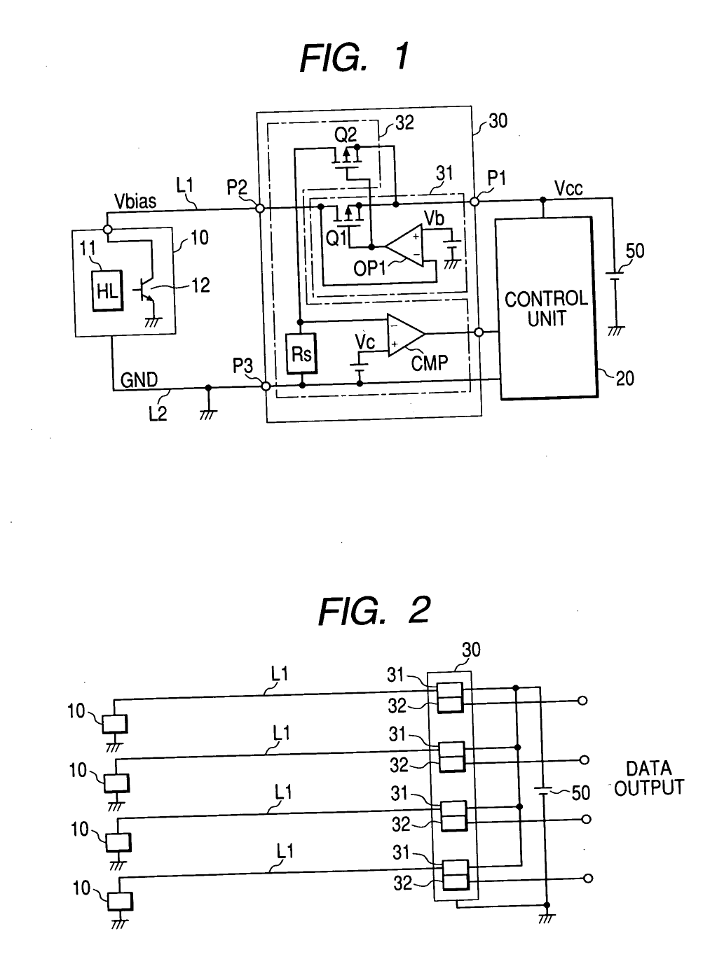

With reference to FIG. 2, the following describes a second embodiment of a Hall element interface circuit according to the present invention, and an example of the configuration of a control system using it.

In the interface circuit 30 of this embodiment, plural pairs of the power supply circuits 31 comprising series regulators as shown in FIG. 1 and the current detecting circuits 32 are provided, and plural Hall ICs 10 and the control unit 20 are coupled by the one interface circuit 30. Since plural Hall ICs are often used as sensors in a car control system, by using the interface circuit 30 of this embodiment, the control device can be miniaturized and costs of the entire system can be reduced. In the interface circuit 30 of this embodiment, a linear lamp may be provided in one or several of the plural current detecting circuits 32, and comparators may be provided in the remaining current detecting circuits 32, whereby binarized output and analog values are outputted according to locations where the sensors are used.

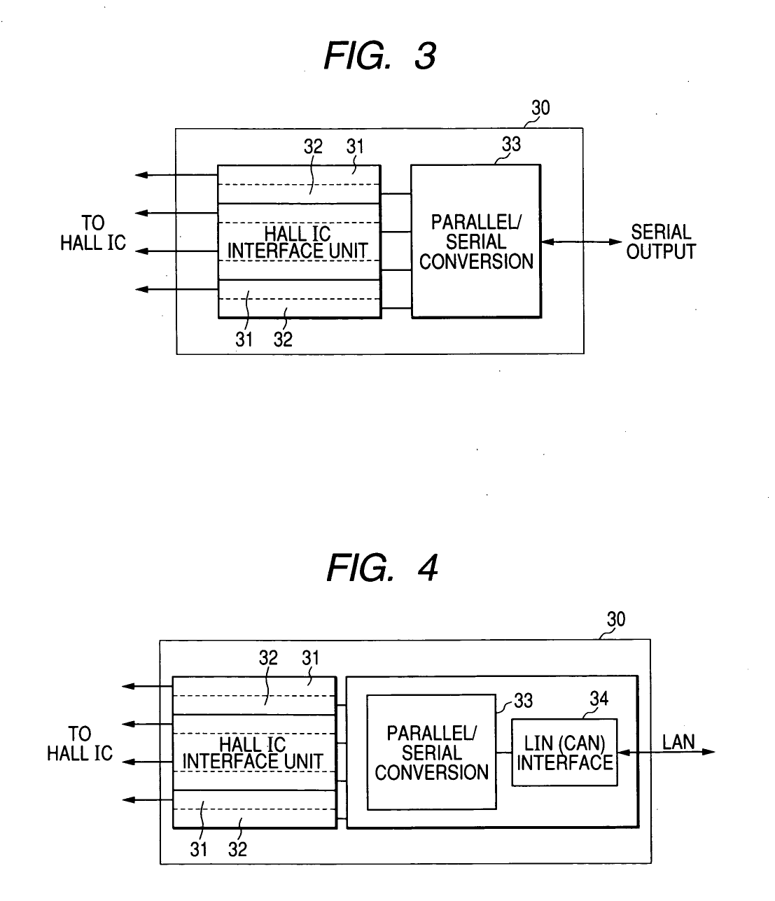

FIGS. 3 and 4 show variants of the interface circuit 30 of the second embodiment. In FIG. 3, a parallel-serial conversion circuit 33 that converts detection outputs of the plural current detecting circuits 32 into serial data is provided so that detection results can be outputted to the control unit as serial data. Since most of general-purpose microcomputers have serial communication ports, advantageously, it is easy to configure a control system using a general-purpose computer as a control unit by using the interface circuit of this variant.

In a large-scale system using several tens of Hall ICs, which cannot be covered by the one interface circuit having the configuration as shown in FIG. 2 and requires plural interface circuits, coupling with the control unit is facilitated by using the interface circuit of this variant. For channels in which linear amplifiers are provided in place of comparators within the interface circuit, this variant can be applied by providing an AD conversion circuit that converts analog output of the linear amplifiers into a digital signal, and subjecting output of the AD conversion circuit to parallel-serial conversion.

A variant of FIG. 4 shows the configuration of an interface circuit suitable to construct an on-vehicle control system. In recent years, with respect to an on-vehicle control system, the specifications of LAN (local area network) called LIN and CAN have been proposed. This variant incorporates an interface 34 corresponding to LIN or CAN. By this construction, this variant can be easily applied to a control system adopting an on-vehicle LAN.

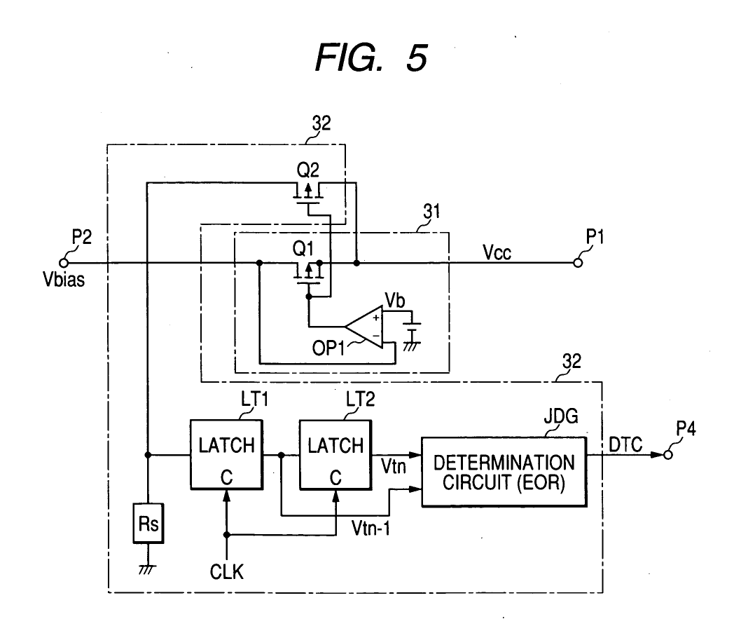

With reference to FIG. 5, the following describes a third embodiment of a Hall element interface circuit according to the present invention.

In this embodiment, the current detecting circuit 32 of the interface circuit is configured with logic circuits. Specifically, it includes: a first latch circuit LT1 that discriminates a voltage signal converted by the resistor Rs by a predetermined threshold value Vth, and latches it synchronously with a clock CLK; a second latch circuit LT2 that latches output of the first latch circuit LT1; and a determination circuit JDG that compares outputs Vtn-1 and Vtn of the two latch circuits LT1 and LT2 to determine whether the signal has changed. The determination circuit JDG can be configured with logical gate circuits such as exclusive OR gates.

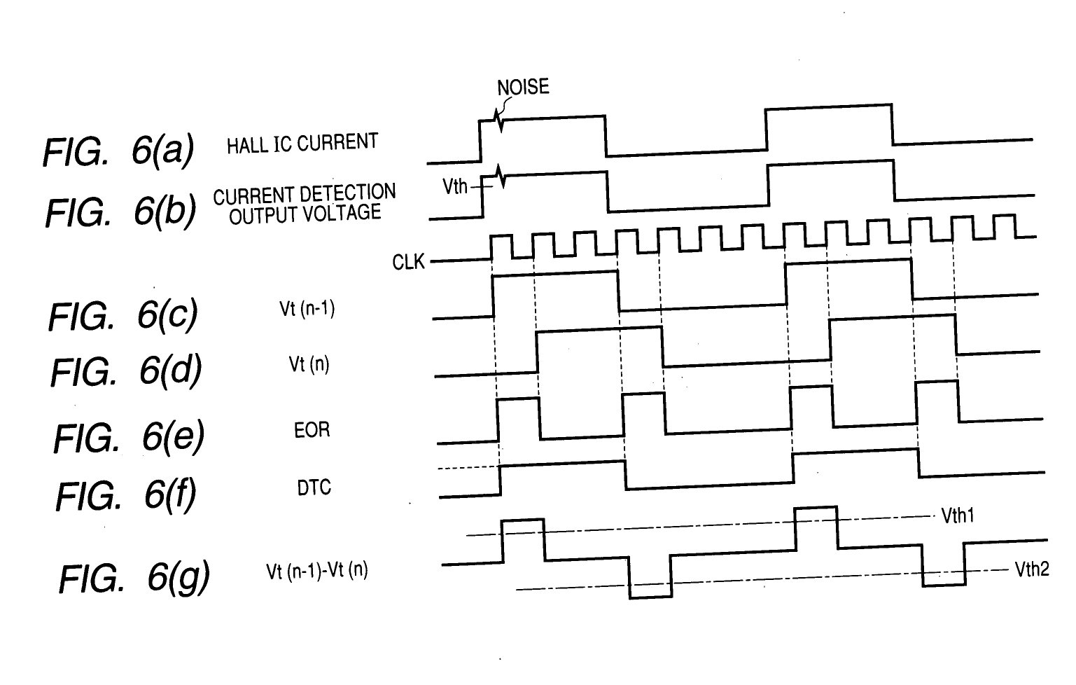

FIG. 6 shows timing of signals of different parts of the current detecting circuit 32 in the interface circuit of this embodiment. In FIG. 6, (a) designates a current flowing through a Hall IC; (b) designates current detection output detected by the resistor Rs or the like; (c) and (d) designate outputs Vt (n−1) and Vt(n) of the latch circuits LT1 and LT2; (e) designates the result of exclusive logical add of Vt (n−1) and Vt(n) and (f) designates determination output DTC of the determination circuit JDG. The determination circuit JDG changes output when an output result of (e) changes from Low to High. The interface circuit of this embodiment has the advantage that no noises appear in output even if noises are generated in currents flowing through the Hall IC and current detection output as shown in (a) and (b) of FIG. 6.

A detected current may be determined by providing the first latch circuit LT1 shown in FIG. 5, a second latch circuit LT2 as a latch unit (sample hold unit) capable of holding analog voltage, a subtracting unit provided in their subsequent stage that finds the difference (Vt (n−1)-Vt (n)) between voltages held in the respective latch units, and a comparator with hysteresis that compares a difference output of the subtracting unit (see (g) of FIG. 6) with predetermined threshold values Vth1 and Vth2.

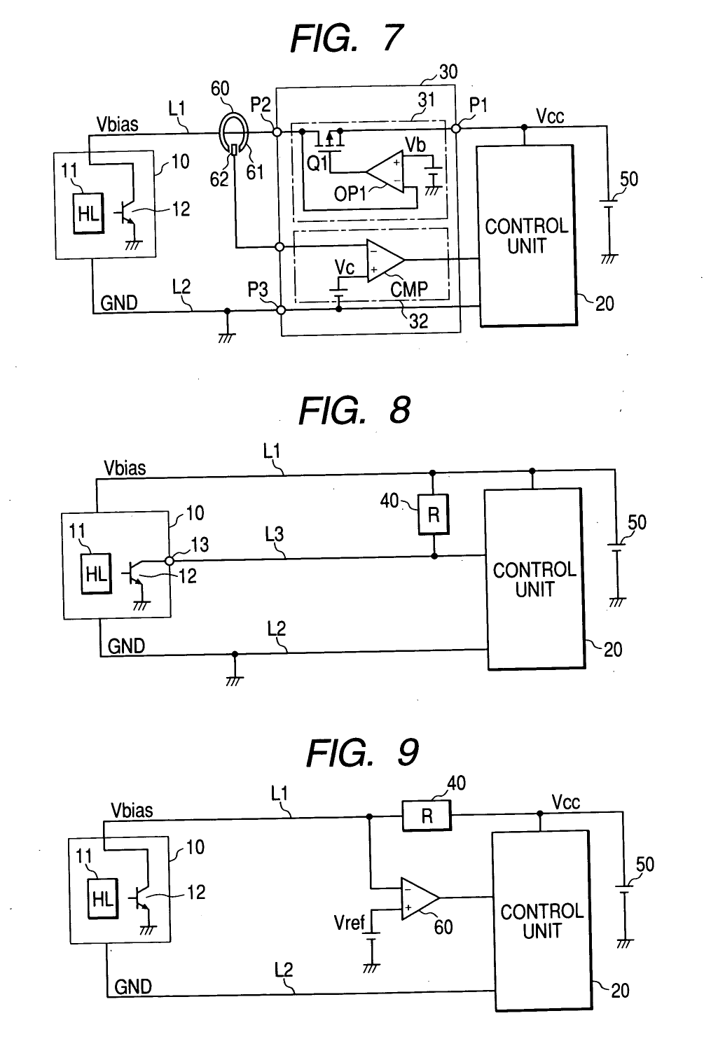

FIG. 7 shows a fourth embodiment of the interface circuit 30.

The interface circuit of this embodiment constitutes the current detecting circuit 32 by a comparator CMP that compares detection output from the current detecting unit 60 detecting a current of the power line L1 provided outside with comparison voltage Vc and determines the comparison result. According to this embodiment, the interface circuit can be simplified and miniaturized in comparison with the embodiment of FIG. 1 because the transistor Q2 and the resistor Rs are not required.

Also in this embodiment, as a variant, in place of the comparator CMP, a linear amplifier may be used to output analog voltage. As a current detecting unit 60 that detects a current of the power line L1, a sensor is available which comprises a ring-shaped magnetic body 61 having several cut locations, disposed around the power line L1, and a Hall element 62 that is disposed in a cut location of the magnetic body 61 and detects a magnetic field occurring in the magnetic body. To make provision for use of a sensor having the Hall element 62, a load resistor may be provided within the interface circuit 30.

According to the embodiments of the present invention, it is possible to realize a Hall element interface circuit that, regardless of the specifications of Hall elements used, contributes to correct detection of magnetism, reduction in heating in the Hall elements, and an increase in reliability, and a system using the Hall element interface circuit.

Furthermore, it is possible to realize a highly versatile Hall element interface circuit that can output detection results to a controller having serial communication functions or an interface capable of coupling to a bus constituting LAN (local area network), and a system using the Hall element interface circuit.

Hereinbefore, the invention made by the inventors has been described concretely based on preferred embodiments. However, it goes without saying that the present invention is not limited to the preferred embodiments, but may be modified in various ways without changing the main purports of the present invention. For example, although, in the above-mentioned embodiments, the system using a two-terminal Hall IC is shown, the interface circuit of this embodiment can also apply to a three-terminal Hall IC. In this case, an external resistor may be coupled between an output terminal of the three-terminal Hall IC and a power supply voltage terminal.

In the above-mentioned embodiments, a description is made of an example of an interface circuit formed as a monolithic IC in which elements constituting the power supply circuit 31 and the current detecting circuit 32 are formed on one semiconductor chip. However, this invention is not limited to the embodiments, and may apply to an interface circuit constructed as a hybrid module in which electronic parts such as plural ICs and discrete resistance elements are mounted on one insulating substrate. Although, in the above-mentioned embodiments, a series regulator is used as a power supply circuit provided in the interface circuit, a switching regulator or shunt regulator may be used.

The present invention is most effectively applied to a control system that has as sensors the Hall ICs used in environments having a large ambient temperature change such as vehicle speed sensor, wheel speed sensor, and crank angle sensor. The present invention can also be used in a control system that uses Hall ICs as position sensors typified by vehicle height adjustment and shift lever, and further in fields other than vehicle such as a control system in home electric products using Hall ICs as sensors for detecting rotator positions of brushless motors and door open/close state of washing machines and air conditioners.

1. An interface circuit comprising:
a power supply circuit that steps-down a power supply voltage supplied from a power supply to generate a drive voltage which is a predetermined voltage applied to a Hall element; and
a current detecting circuit that detects a current supplied to the Hall element from the power supply circuit,
wherein the interface circuit is coupled between the Hall element and a control circuit.

2. An interface circuit in which a power supply circuit that converts a power supply voltage supplied from a power supply to generate a drive voltage applied to a Hall element, and a current detecting circuit that detects a current supplied from the power supply circuit to the Hall element are formed on one semiconductor chip, and which is coupled between the Hall element and a control circuit.

3. The interface circuit according to claim 1, including plural pairs of the power supply circuit and the current detecting circuit and being capable of coupling between plural Hall elements and the control circuit.

4. The interface circuit according to claim 2,
wherein the current detecting circuit includes a voltage comparison and generation circuit that compares a voltage converted from the detected current with a predetermined voltage.

5. The interface circuit according to claim 2, wherein the current detecting circuit includes a current-voltage conversion unit that converts the detected current into a voltage, and a voltage comparison circuit that compares the converted voltage with a predetermined voltage.

6. The interface circuit according to claim 2,
wherein the current detecting circuit includes an amplifying circuit that outputs a proportional voltage to the converted voltage from the detected current.

7. An interface circuit comprising:
a power supply circuit that steps-down a power supply voltage supplied from a power supply to generate a drive voltage applied to a Hall element; and
a current detecting circuit that detects a current supplied to the Hall element from the power supply circuit,
wherein the power supply voltage includes a voltage control transistor that outputs the drive voltage upon receiving the power supply voltage, and an operational-amplifier circuit that is input the drive voltage and a predetermined reference voltage as inputs, and drives and controls the voltage control transistor, and
wherein the current detecting circuit includes a transistor that receives a control voltage identical with the voltage control transistor to a control terminal from the operational-amplifier circuit and flows a proportional current to a current flowing through the voltage control transistor, and a voltage comparison and generation circuit that compares a voltage converted from a current flowing through the transistor with a predetermined voltage.

8. The interface circuit according to claim 7,
wherein the current detecting circuit further includes a current-voltage conversion unit that converts, into a voltage, a current flowing through the transistor which makes the proportional current flow.

9. The interface circuit according to claim 7, including plural pairs of the power supply circuit and the current detecting circuit and being capable of coupling between plural Hall elements and a control circuit.

10. A system comprising:
a Hall element;
an interface circuit comprising a power supply circuit that converts a power supply voltage supplied from a power supply to generate a drive voltage applied to the Hall element, and a current detecting circuit that detects a current supplied from the power supply circuit to the Hall element; and
a control circuit that receives detection output outputted from the interface circuit.

11. The system according to claim 10,
wherein the interface circuit includes plural pairs of the power supply circuit and the current detecting circuit and is coupled to plural Hall elements.

12. The system according to claim 10,
wherein the interface circuit is formed on one semiconductor chip as a semiconductor integrated circuit.

13. The system according to claim 10,
wherein the Hall element is a two-terminal element that includes a power supply voltage terminal to which a drive voltage from the power supply circuit is applied, and a ground terminal to which reference potential is applied.

14. A system comprising:
plural Hall elements; and
an interface circuit comprising plural pairs of a power supply circuit that steps-down a power supply voltage supplied from a power supply to generate a drive voltage which is a predetermined voltage applied to the Hall elements, and a current detecting circuit that detects a current supplied from the power supply circuit to the Hall elements,
wherein the interface circuit includes a parallel-serial conversion circuit that converts outputs of the plural current detecting circuits into serial signals.

15. The system according to claim 14,
wherein the interface circuit includes a LAN interface capable of coupling to a bus or cable of a local area network.
